(19) United States
(12) Patent Application Publication
(10) Pub. No.: US 2022/0009496 A1
(43) Pub. Date: Jan. 13, 2022

(54) VEHICLE CONTROL DEVICE, VEHICLE CONTROL METHOD, AND NON-TRANSITORY COMPUTER-READABLE MEDIUM

(71) Applicant: PANASONIC INTELLECTUAL PROPERTY MANAGEMENT CO., LTD., Osaka (JP)

(72) Inventors: Iori UEDA, Kanagawa (JP); Shota AKAURA, Kanagawa (JP); Yuya MATSUMOTO, Tokyo (JP)

(73) Assignee: PANASONIC INTELLECTUAL PROPERTY MANAGEMENT CO., LTD., Osaka (JP)

(21) Appl. No.: 17/487,445

(22) Filed: Sep. 28, 2021

Related U.S. Application Data
(63) Continuation of application No. PCT/JP2020/005418, filed on Feb. 12, 2020.

(30) Foreign Application Priority Data
Mar. 29, 2019 (JP) 2019-068783

(51) Int. Cl. B60W 30/18; B60W 30/09; G06K 9/00

(52) U.S. Cl. CPC B60W 30/18163; B60W 30/09; G06K 9/00818; G06K 9/00798; B60W 2554/4041; B60W 2554/20; B60W 2555/60; B60W 2552/53; B60W 2554/4042; B60W 2520/10; B60W 2420/42

(57) ABSTRACT

A vehicle control device is configured to control traveling of a vehicle capable of self-driving. The vehicle control device includes a processor and a memory storing instructions that, when executed by the processor, cause the vehicle control device to perform operations including: determining a control condition related to vehicle traveling when an own vehicle as a control target vehicle is in automated traveling by self-driving; and controlling traveling of the own vehicle based on a determination result. The determining the control condition includes, in a case in which an obstacle is present in front of the own vehicle, determining, as the control condition, whether passing is possible and further whether overtaking is possible. The controlling the traveling of the own vehicle comprises executing the passing or the overtaking or another travel control in accordance with whether the passing is possible and whether the overtaking is possible.

### CROSS-REFERENCE TO RELATED APPLICATIONS

This application is a continuation of PCT International Patent Application No. PCT/JP2020/005418 filed on Feb. 12, 2020, which claims the benefit of priority of Japanese Patent Application No. 2019-068783 filed on Mar. 29, 2019, the entire contents of which are incorporated herein by reference.

### FIELD

The present disclosure relates to a vehicle control device, a vehicle control method, and a program for controlling travel of a vehicle.

### BACKGROUND

Various travel control devices have been proposed that control travel of a vehicle, such as a vehicle speed, steering, and braking. In addition, a vehicle having a self-driving function to which these travel control devices are applied has been proposed. As a device that controls travel of a vehicle, for example, a vehicle travel control device capable of performing an automated overtaking operation is disclosed (see JP-A-2003-63273). The vehicle travel control device of JP-A-2003-63273 has a configuration in which, during inter-automobile control travel, when a vehicle speed of a preceding vehicle is lower than a set vehicle speed of an own vehicle, it is determined whether the preceding vehicle can be overtaken based on a travel position of the own vehicle, road information, and the like, and when it is possible to overtake the preceding vehicle, an automated operation of overtaking the preceding vehicle is performed. Accordingly, when there is a vehicle traveling ahead at a speed lower than the set vehicle speed, overtaking can be performed by self-driving.

### SUMMARY

An object of the present disclosure is to provide a vehicle control device, a vehicle control method, and a program capable of appropriately controlling travel of a vehicle such as overtaking.

According to an aspect of the present disclosure, there is provided a vehicle control device configured to control traveling of a vehicle capable of self-driving, the vehicle control device including: a processor; and a memory storing instructions that, when executed by the processor, cause the vehicle control device to perform operations including: determining a control condition related to vehicle traveling when an own vehicle as a control target vehicle is in automated traveling by self-driving; and controlling traveling of the own vehicle based on a determination result, wherein the determining the control condition includes, in a case in which an obstacle is present in front of the own vehicle, determining, as the control condition, whether passing is possible and further whether overtaking is possible, and wherein the controlling the traveling of the own vehicle includes executing the passing or the overtaking or another travel control in accordance with whether the passing is possible and whether the overtaking is possible.

According to an aspect of the present disclosure, there is provided a vehicle control method in a vehicle control device configured to control traveling of a vehicle capable of self-driving, the vehicle control method including: determining a control condition related to vehicle traveling when an own vehicle as a control target vehicle is in automated traveling by self-driving; and controlling traveling of the own vehicle based on a determination result, wherein the determining the control condition includes, in a case in which an obstacle is present in front of the own vehicle, determining whether passing is possible and further whether overtaking is possible as the control condition, and wherein the controlling the traveling of the own vehicle includes executing the passing or the overtaking or another travel control in accordance with whether the passing is possible and whether the overtaking is possible.

According to an aspect of the present disclosure, there is provided a non-transitory computer-readable medium storing a program that, when executed by a processor, cause a computer to execute a vehicle control method for controlling traveling of a vehicle capable of self-driving, the vehicle control method including; determining a control condition related to vehicle traveling when an own vehicle as a control target vehicle is in automated traveling by self-driving; and controlling traveling of the own vehicle based on a determination result, wherein the determining the control condition includes determining, as the control condition, whether passing is possible and further whether overtaking is possible in a case in which an obstacle is present in front of the own vehicle, and wherein the controlling the traveling of the own vehicle includes executing the passing or the overtaking or another travel control in accordance with whether the passing is possible and whether the overtaking is possible.

### BRIEF DESCRIPTION OF DRAWINGS

FIG. 1 is a block diagram illustrating an example of a configuration of a vehicle control device according to an embodiment.

FIG. 2 is a flowchart illustrating a processing procedure related to travel control of the vehicle control device according to the embodiment.

FIG. 3 is a diagram illustrating a first example (passing) of travel control according to the embodiment.

FIG. 4 is a diagram illustrating a second example (overtaking) of travel control according to the embodiment.

FIG. 5 is a diagram illustrating a third example (passing at the time when entering an oncoming lane is not possible) of travel control according to the embodiment.

FIG. 6 is a diagram illustrating a fourth example (obstacle avoidance at the time when passing is not possible) of travel control according to the embodiment.

FIG. 7 is a diagram illustrating a fifth example (stop and deceleration at the time when passing is not possible) of travel control according to the embodiment.

### DETAILED DESCRIPTION

(Findings Leading to Present Disclosure)

As described above, when travel control of a vehicle is performed under self-driving, appropriate control according to a road state is required for traveling at the time of performing overtaking a preceding vehicle or the like.

For example, in the vehicle travel control device of JP-A-2003-63273, it is determined whether overtaking can be performed, based on information such as a traveling position of an own vehicle, a set speed of the own vehicle, a preceding vehicle in a lane in which the own vehicle is traveling and an adjacent lane, and a curve curvature of a traveling road. When there is an obstacle element for overtaking such as traffic congestion, construction work, an accident, a tollgate, a traffic light, or an intersection in a traveling direction, based on traffic information of a road on which the own vehicle travels, overtaking is not performed. In such a conventional example, since travel control for overtaking is not performed at all when there is an obstacle element in overtaking, there is a problem that appropriate control according to a road state cannot be performed at the time of performing travel control of a vehicle under self-driving.

Therefore, in the present disclosure, a configuration example of a vehicle control device capable of appropriately controlling traveling of a vehicle such as overtaking according to a road state will be described.

Hereinafter, embodiments specifically disclosing a vehicle control device, a vehicle control method, and a program according to the present disclosure will be described in detail with reference to the accompanying drawings as appropriate. An unnecessarily detailed description may be omitted. For example, a detailed description of a well-known matter or a repeated description of substantially the same configuration may be omitted. This is to avoid unnecessary redundancy in the following description and to facilitate understanding of those skilled in the art. Note that the accompanying drawings and the following description are provided to provide a thorough understanding of the present disclosure for those skilled in the art, and are not intended to limit the subject matter recited in the claims.

In the following embodiments, as an example of a vehicle control device, a configuration example of a device including a vehicle control unit that controls traveling of a vehicle capable of self-driving will be described.

### Configuration of Embodiment

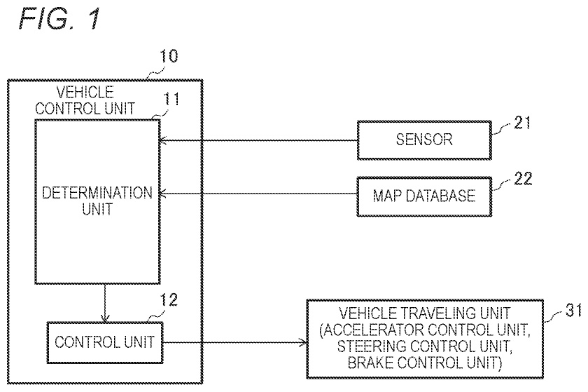

FIG. 1 is a block diagram illustrating an example of a configuration of a vehicle control device according to an embodiment.

A vehicle control unit 10 is provided, for example, in an electronic control unit (ECU) or an engine control unit (ECU) that controls each unit of a vehicle. The vehicle control unit 10 includes a processor and a memory, and implements various functions, for example, by the processor executing a predetermined program held in the memory or a storage. The processor may include a micro processing unit (MPU), a central processing unit (CPU), a digital signal processor (DSP), a graphical processing unit (GPU), and the like. The memory may include a random access memory (RAM), a read only memory (ROM), and the like. The storage may include a hard disk drive (HDD), a solid state drive (SSD), an optical disk device, a memory card, and the like. The vehicle control unit 10 performs travel control in a case where a control target vehicle is in automated traveling under self-driving. The vehicle control unit 10 includes a determination unit 11 and a control unit 12 as functional configurations.

The vehicle control unit 10 is connected to a sensor 21, which serves as an information input device, and a map database 22. The sensor 21 includes a light detection and ranging (LiDAR) and a camera, and acquires sensor detection information such as object detection information on surroundings of the vehicle and image information. The sensor 21 may include a satellite positioning system receiver for a positioning system such as a global positioning system (GPS), a millimeter wave radar, a gyro, a range finder, and the like. The map database 22 holds map information including road information. The vehicle control unit 10 is connected to a vehicle traveling unit 31 serving as a controlled device. The vehicle traveling unit 31 includes an accelerator control unit, a steering control unit, a brake control unit, and the like, and performs traveling of the vehicle by controlling elements related to vehicle traveling, such as a vehicle speed (acceleration, constant speed, deceleration), steering, and braking.

In the vehicle control unit 10, the determination unit 11 determines a control condition related to vehicle traveling. The control unit 12 controls traveling of the vehicle based on a determination result of the determination unit 11. The determination unit 11 acquires a position of an own vehicle. For example, the determination unit 11 acquires information related to the own vehicle by using sensor detection information acquired by the sensor 21 and map information held in the map database 22. Examples of the sensor detection information include the object detection information and the image information. The map information includes road information. Examples of the information related to the own vehicle to be acquired include own-vehicle position information indicating a position of the own vehicle, road state information on surroundings of the vehicle, other-vehicle information and obstacle information. The determination unit 11 determines a control condition for controlling the controlled device at the time of vehicle traveling, based on acquired own-vehicle position information and the like. The control unit 12 controls the vehicle traveling unit 31 according to a determination result of the control condition, and controls a vehicle speed (acceleration, constant speed, deceleration), steering, braking, and the like in automated traveling of the vehicle.

The LiDAR serving as the sensor 21 can acquire information on various objects as the object detection information. Examples of the object detection information include presence or absence of an obstacle (including another vehicle) in the surroundings of an own vehicle, a distance to an obstacle, a road shoulder of a road, a center strip, a guardrail, and a line on a road (a center line, a stop line, or the like). The camera serving as the sensor 21 can acquire various types of image information as the image information. Examples of the image information include an obstacle in the surroundings of an own vehicle, another vehicle, a road sign, a signal, a road shoulder of a road, a center strip, a guardrail, and a line and a road marking (a lane boundary line, a center line, a roadside strip, a stop line, a crosswalk, and the like).

The determination unit 11 can acquire position information of the own vehicle (own-vehicle position information) based on the object detection information from the sensor 21 and the map information in the map database 22. In acquisition of the own-vehicle position information, position detection information by a satellite positioning system receiver may be used as auxiliary information. In addition, based on the own-vehicle position information, the determination unit 11 can acquire road information (presence or absence of prohibition of entering an oncoming lane, the number of lanes, a speed limit, and the like) of a road on which the vehicle is currently traveling. Further, based on the image information from the sensor 21, the determination unit 11 can recognize a type of a road sign, a type of a signal, a position a line on a road and a type thereof (dotted white line, solid white line, or solid yellow line), a position and a distance of a stop line or a crosswalk, and the like. In addition, when an obstacle is present in the surroundings, the determination unit 11 can determine whether the obstacle is a vehicle or another obstacle other than a vehicle based on the object detection information from the sensor 21. In addition, when another vehicle is detected in the surroundings, the determination unit 11 can determine a type of the vehicle (a passenger vehicle such as a bus, a cargo vehicle such as a truck, a motorcycle, a motorized bicycle, a bicycle, or the like). In addition, when another vehicle is detected in the surroundings, the determination unit 11 can detect a traveling speed (in traveling or in stoppage) of the vehicle. In addition, when another vehicle is detected in the surroundings, the determination unit 11 can determine whether the vehicle is a stopped vehicle or a parked vehicle based on the object detection information from the sensor 21 and the image information.

The vehicle control unit 10 of the present embodiment executes control related to overtaking and passing as travel control of the vehicle. In the present specification, the following description will be made on assumptions that “overtaking” refers to a passing in which an own vehicle enters an oncoming lane and comes in front of a preceding vehicle with a lane change on a road, and “passing” refers to a passing in which an own vehicle comes in front of a preceding vehicle without entering an oncoming lane. Note that a case of no entry into an oncoming lane is included in “passing”. Examples of the case of no entry into an oncoming lane include a case where an own vehicle comes in front of a preceding vehicle in the same lane, and a case where, on a road having a plurality of lanes (vehicular lanes) in the same traveling direction, an own vehicle comes in front of a preceding vehicle with a lane change in the plurality of lanes in the same traveling direction.

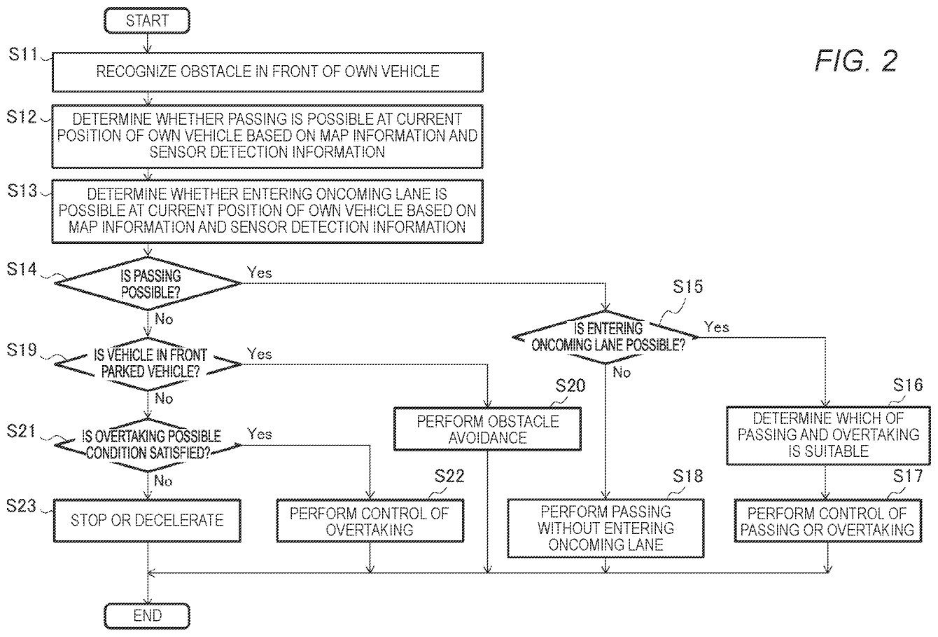

FIG. 2 is a flowchart illustrating a processing procedure related to travel control of the vehicle control device according to the embodiment. Hereinafter, the processing of travel control related to overtaking and passing by the vehicle control unit 10 will be described.

The determination unit 11 of the vehicle control unit 10 recognizes that there is an obstacle in front of an own vehicle based on sensor detection information (object detection information, image information) from the sensor 21 while the own vehicle is traveling (S11). Here, the determination unit 11 recognizes that an obstacle is present within a predetermined distance and that the own vehicle approaches the obstacle. When there is an obstacle in front of the own vehicle, the determination unit 11 acquires own-vehicle position information by using the sensor detection information from the sensor 21 and map information in the map database 22. Then, the determination unit 11 determines whether passing is possible at a current position of the own vehicle based on the own-vehicle position information (S12). At this time, the determination unit 11 recognizes a road on which the own vehicle is currently traveling and a position on the road based on the own-vehicle position information, and determines whether passing is possible. In addition, the determination unit 11 may perform image recognition by using the image information, recognize a road sign or a road making, and determine whether a section is a section where passing is possible. In addition, the determination unit 11 may recognize an obstacle or a vehicle in front based on the object detection information and the image information, and determine whether passing is possible based on whether there is a space for passing in a traveling lane.

In addition, the determination unit 11 of the vehicle control unit 10 determines whether it is possible to enter an oncoming lane at the current position of the own vehicle, based on the own-vehicle position information (S13). That is, the determination unit 11 identifies whether it is not prohibited from entering the oncoming lane at the current position of the own vehicle, and determines whether overtaking involving lane change of entering the oncoming lane is possible. At this time, the determination unit 11 recognizes the road on which the own vehicle is currently traveling and the position on the road based on the own-vehicle position information, and determines whether entering the oncoming lane is possible (overtaking possible). In addition, the determination unit 11 may perform image recognition by using the image information, recognize a road sign, and determine whether a section is a section where entering the oncoming lane is not prohibited.

Then, the determination unit 11 outputs, to the control unit 12, a determination result as to whether passing is possible and a determination result as to whether entering the oncoming lane is possible, and the control unit 12 executes travel control of the vehicle according to the determination results of passing and overtaking. The determination unit 11 determines whether passing is possible (S14), and when passing is possible, subsequently determines whether entering the oncoming lane is possible (whether overtaking is possible) (S15). Here, when entering the oncoming lane is possible (S15: Yes), the determination unit 11 determines which of passing and overtaking is suitable for the obstacle in front (S16). At this time, the determination unit 11 determines which of passing in the same lane and overtaking by entering the oncoming lane is preferable, based on presence or absence of an oncoming vehicle, a speed of the own vehicle, a speed of a preceding vehicle in a case where the obstacle is a vehicle, and the like acquired from the sensor detection information on surroundings of the vehicle, and outputs a determination result of performing the preferable passing or overtaking to the control unit 12. Then, the determination unit 11 causes control of passing or overtaking based on the determination result to be executed (S17). The control unit 12 transmits a control instruction for passing or overtaking to the vehicle traveling unit 31 according to a determination result of a control condition by the determination unit 11, and executes travel control for performing passing or overtaking with respect to the obstacle in front.

In addition, when entering the oncoming lane is prohibited (S15: No), the determination unit 11 determines that only passing is possible, and outputs a determination result of performing passing without entering the oncoming lane to the control unit 12 (S18). The control unit 12 transmits a control instruction for passing to the vehicle traveling unit 31 according to a determination result of a control condition by the determination unit 11, and executes travel control for performing passing in the same lane or in a plurality of lanes in the same traveling direction without entering the oncoming lane with respect to the obstacle in front.

On the other hand, when passing is not possible (S14: No), the determination unit 11 identifies the obstacle in front based on the image information of the sensor detection information, and when the obstacle is a vehicle, the determination unit 11 determines whether the vehicle in front is a parked vehicle (S19). At this time, the determination unit 11 identifies whether the vehicle in front is a parked vehicle by using the image information on the surroundings of the own vehicle. When the vehicle in front is a parked vehicle (S19: Yes), the determination unit 11 outputs a determination result of traveling while avoiding the obstacle of the parked vehicle to the control unit 12 (S20). Similarly, when the obstacle is other than a vehicle, the determination unit 11 outputs a determination result of traveling while avoiding the obstacle to the control unit 12. The control unit 12 transmits a control instruction for obstacle avoidance to the vehicle traveling unit 31 according to a determination result of a control condition by the determination unit 11, and executes travel control for avoiding the obstacle in front.

When the vehicle in front is not a parked vehicle but a vehicle in traveling (S19: No), the determination unit 11 determines whether a condition that passing is not possible but overtaking is possible is satisfied (S21). As a condition that passing is not possible but overtaking is possible, for example, there may be a case where a road width is less than 6 m, overtaking is not prohibited, and it is determined that overtaking of the vehicle in front is possible within a speed limit. Specifically, it is conceivable to avoid a vehicle in front traveling at a low speed on a road with one lane on each side having a small margin of width. The determination unit 11 determines conditions such as a road width, overtaking prohibition, and a traveling speed of a vehicle based on the sensor detection information. When the condition that passing is not possible but overtaking is possible is satisfied (S21: Yes), the determination unit 11 outputs a determination result of performing overtaking to the control unit 12 and causes the control unit 12 to execute control of overtaking (S22). The control unit 12 transmits a control instruction for passing to the vehicle traveling unit 31 according to a determination result of a control condition by the determination unit 11, and executes travel control for overtaking the vehicle in front.

In addition, when passing and overtaking are not possible (S21: No), the determination unit 11 identifies, for example, a stopped vehicle that is stopped at a stop line of a crosswalk or the like, a passenger vehicle that is stopped at a stop, or a passenger vehicle that departs from a stop and is about to return to a lane. Then, the determination unit 11 outputs, to the control unit 12, a determination result of stopping or decelerating the own vehicle behind the vehicle in front that is traveling (S23). The control unit 12 transmits a control instruction for stop or deceleration to the vehicle traveling unit 31 according to a determination result of a control condition by the determination unit 11, and executes travel control for stopping or decelerating in accordance with the vehicle in front. When the vehicle in front is a stopped vehicle that is stopped at a stop line of a crosswalk or the like, the determination unit 11 causes travel control of stopping the own vehicle at a position aligned with the vehicle in front to be performed. When the vehicle in front is a passenger vehicle, the determination unit 11 causes travel control of stopping or decelerating in accordance with movement of the vehicle in front to be performed so that the own vehicle does not come ahead of the vehicle in front.

Next, some specific examples of travel control related to passing or overtaking according to the present embodiment will be exemplified and described.

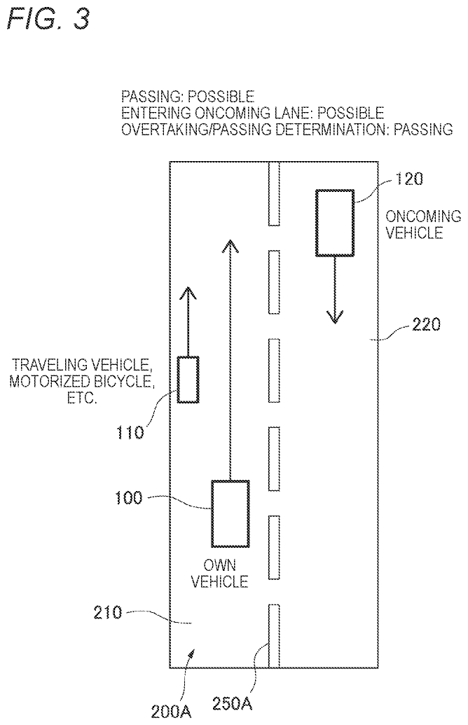

FIG. 3 is a diagram illustrating a first example (passing) of travel control according to the embodiment. The first example illustrates an example of a case in which passing is performed in a situation in which passing and entering an oncoming lane are possible at an own-vehicle position during current traveling. A road 200A on which an own vehicle 100 is currently traveling is a center line 250A of a white line, and is a section where entering an oncoming lane is possible. Here, a preceding vehicle 110 such as a motorized bicycle travels at a low speed in the front of a traveling lane 210 of the own vehicle 100, and the own vehicle 100 catches up with and approaches the preceding vehicle 110 of a traveling vehicle. On the other hand, an oncoming vehicle 120 is present in an oncoming lane 220 and travels from the front. In this case, in a situation where passing or overtaking is possible, the determination unit 11 of the vehicle control unit 10 determines that passing is suitable because the oncoming vehicle 120 is present. Then, the control unit 12 of the vehicle control unit 10 controls traveling of the own vehicle 100 according to a determination result of passing by the determination unit 11 so as to perform passing with respect to the preceding vehicle 110 in the same lane.

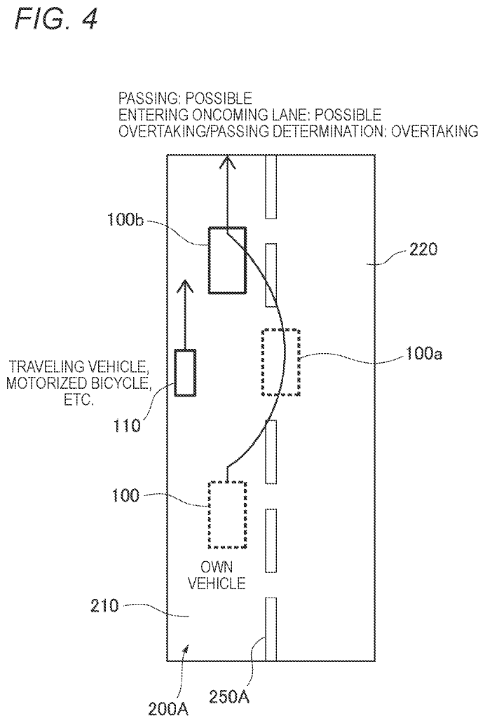

FIG. 4 is a diagram illustrating a second example (overtaking) of travel control according to the embodiment. The second example illustrates an example of a case in which overtaking is performed in a situation in which passing and entering an oncoming lane are possible at an own-vehicle position during current traveling. The road 200A on which the own vehicle 100 is currently traveling is the center line 250A of a white line, and is a section where entering an oncoming lane is possible. In the second example, there is the preceding vehicle 110 traveling at a low speed in the front of the traveling lane 210, and the own vehicle 100 is catching up with the preceding vehicle 110 of a traveling vehicle, but there is no oncoming vehicle in the oncoming lane 220. In this case, in a situation where passing or overtaking is possible, the determination unit 11 of the vehicle control unit 10 determines that overtaking is suitable because there is no obstacle in front on the oncoming lane side. Then, the control unit 12 of the vehicle control unit 10 controls traveling of the own vehicle 100 according to a determination result of overtaking by the determination unit 11 so as to entering the oncoming lane 220 to overtake the preceding vehicle 110 (reference signs 100→100a→100b).

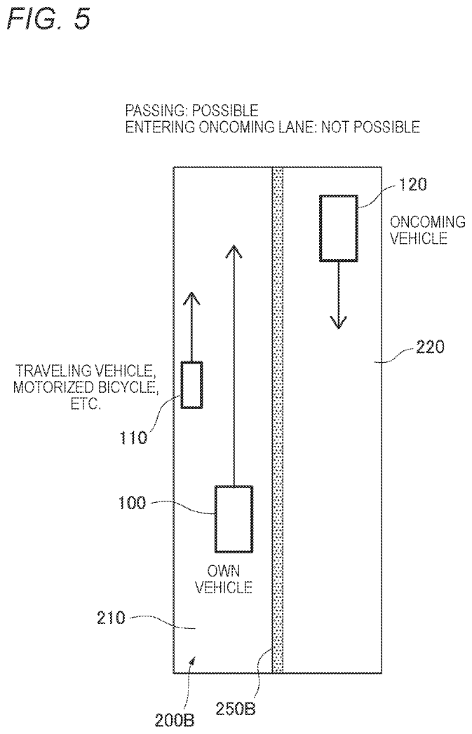

FIG. 5 is a diagram illustrating a third example (passing at the time when crossing is not possible) of travel control according to the embodiment. The third example illustrates an example of a case in which passing is performed in a situation in which passing is possible but entering an oncoming lane is not possible at an own-vehicle position during current traveling. A road 200B on which the own vehicle 100 is currently traveling is a center line 250B of a yellow line, and is a section where entering the oncoming lane 220 is prohibited. Here, the preceding vehicle 110 such as a motorized bicycle travels at a low speed in the front of the traveling lane 210 of the own vehicle 100, and the own vehicle 100 catches up with and approaches the preceding vehicle 110 of a traveling vehicle. In this case, since entering the oncoming lane 220 is not possible regardless of presence or absence of the oncoming vehicle 120, the determination unit 11 of the vehicle control unit 10 outputs a determination result of performing passing without entering the oncoming lane 220. Then, the control unit 12 of the vehicle control unit 10 controls traveling of the own vehicle 100 according to a determination result of passing by the determination unit 11 so as to perform passing with respect to the preceding vehicle 110 in the same lane.

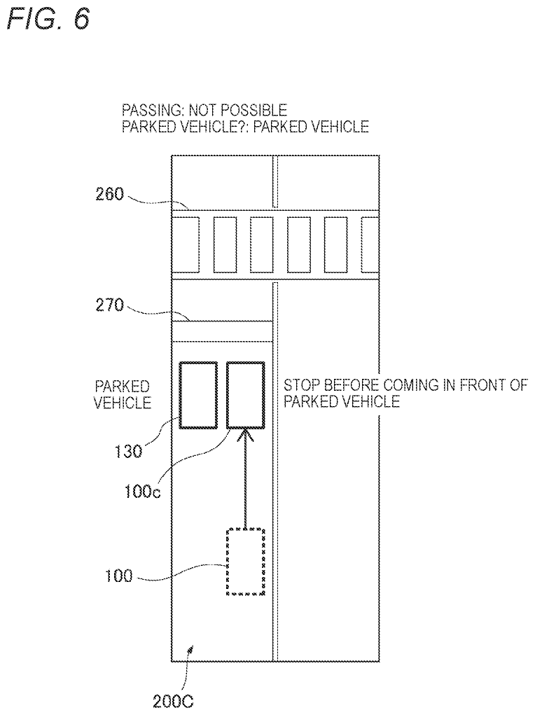

FIG. 6 is a diagram illustrating a fourth example (obstacle avoidance at the time when passing is not possible) of travel control according to the embodiment. The fourth example illustrates an example of a case in which obstacle avoidance is performed with respect to a parked vehicle in front in a situation in which passing is not possible at an own-vehicle position during current traveling. On a road 200C on which the own vehicle 100 is currently traveling, there are a crosswalk 260 and a stop line 270 in front (for example, within 30 m), and the own vehicle 100 is positioned in a section where passing is not possible. In addition, a parked vehicle 130 is present in the vicinity of the front of the stop line 270. In this case, the determination unit 11 of the vehicle control unit 10 recognizes that a vehicle in front is the parked vehicle 130, and outputs a determination result of performing obstacle avoidance. Then, the control unit 12 of the vehicle control unit 10 controls traveling of the own vehicle 100 according to the determination result of obstacle avoidance by the determination unit 11 so as to avoid the parked vehicle 130. For example, the travel of the own vehicle 100 is controlled such that the own vehicle 100 stops before coming in front of the parked vehicle 130 (reference signs 100→100c) and thereafter passes from a side of the parked vehicle 130.

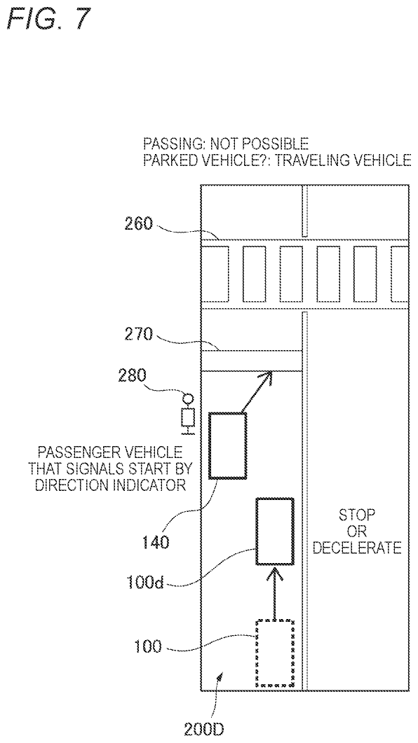

FIG. 7 is a diagram illustrating a fifth example (stop and deceleration at the time when passing is not possible) of travel control according to the embodiment. The fifth example illustrates an example of a case in which stop or deceleration is performed with respect to a passenger vehicle in front in a situation in which passing is not possible at an own-vehicle position during current traveling. On a road 200D on which the own vehicle 100 is currently traveling, there are the crosswalk 260 and the stop line 270 in front (for example, within 30 m), a stop 280 exists in front of the stop line 270, and the own vehicle 100 is positioned in a section where passing is not possible. This is a situation in which a passenger vehicle 140 is stopped at the stop 280 and is about to depart after signaling start by using a direction indicator. In this case, the determination unit 11 of the vehicle control unit 10 recognizes that the vehicle in front is not a parked vehicle but the passenger vehicle 140 of a traveling vehicle and is stopped at the stop or is about to depart from the stop to return to a lane, and outputs a determination result of performing stop or deceleration. Then, the control unit 12 of the vehicle control unit 10 controls traveling of the own vehicle 100 according to the determination result of stop or deceleration by the determination unit 11 so that the own vehicle 100 is stopped or decelerated to give the passenger vehicle 140 priority. For example, the traveling of the own vehicle 100 is controlled such that the own vehicle 100 is stopped or decelerated without coming in front of the passenger vehicle 140 (reference signs 100→100d) and the passenger vehicle 140 travels first. When the vehicle in front is a traveling vehicle but is stopped at the stop line 270 as a stopped vehicle, travel control of stopping the own vehicle is executed so that the own vehicle does not come ahead of the vehicle in front.

According to the present embodiment, in a case where an obstacle is present in front and passing, overtaking or the like is to be performed while a control target vehicle is in automated traveling by self-driving, appropriate control can be performed according to a road state. For example, even when there is an obstacle element for overtaking such as a crosswalk or a traffic light, it is possible to determine a control condition such as whether overtaking is possible, according to a road state such as whether passing or overtaking at a current position is possible, whether an oncoming vehicle is present, and whether a parked vehicle is present, and appropriately perform travel control of the vehicle by self-driving. At this time, traveling of the vehicle can be controlled by appropriately selecting passing, overtaking or other travel control.

In addition, when both passing and overtaking are possible, it is possible to control traveling by selecting a preferable one of passing and overtaking, according to a width of a traveling lane, an interval between the own vehicle and a preceding vehicle, presence or absence of an oncoming vehicle, and the like. In addition, when overtaking is not possible, it is possible to execute travel control of performing passing without entering an oncoming lane. In addition, when passing is not possible, an obstacle in front can be identified, and when the obstacle is a parked vehicle, travel control for performing obstacle avoidance can be executed. In addition, when passing is not possible and an obstacle in front is a vehicle in traveling such as a passenger vehicle, it is possible to control traveling such that the own vehicle is stopped or decelerated behind in accordance with the vehicle in front. At this time, in the case of the passenger vehicle, it is possible to execute control of stopping or decelerating the own vehicle to allow the passenger vehicle to travel first and giving the passenger vehicle a priority in traveling. In the case of a stopped vehicle that is stopped at a stop line, it is possible to execute control of stopping the own vehicle so as not to come in front of the stopped vehicle.

As described above, the vehicle control device, the vehicle control method, and the program according to the present embodiment control traveling of a vehicle capable of self-driving, and include, for example, the vehicle control unit 10 including a processor and a memory. In a case where an own vehicle, which is a control target vehicle, is in automated traveling by self-driving, the vehicle control unit 10 includes the determination unit 11 that determines a control condition related to vehicle traveling and the control unit 12 that controls traveling of the own vehicle based on a determination result of the determination unit 11. When an obstacle is present in front of the own vehicle, the determination unit 11 determines whether passing is possible, as a control condition, and further determines whether overtaking is possible. For example, the determination unit 1I acquires sensor detection information on surroundings of the own vehicle detected by the sensor 21 and map information. The determination unit 11 may determine that an obstacle is present in front of the own vehicle based on the sensor detection information. The determination unit 11 may acquire own-vehicle position information indicating a position of the own vehicle, based on the sensor detection information and the map information, and may determine whether passing and overtaking are possible based on the own-vehicle position information. The control unit 12 performs passing, overtaking or other travel control according to whether passing is possible and whether overtaking is possible. Passing is vehicle traveling in which the own vehicle comes in front of a preceding vehicle without entering an oncoming lane of a road on which the own vehicle is traveling, and overtaking is vehicle traveling in which an own vehicle comes in front of a preceding vehicle by entering an oncoming lane. The other travel control is vehicle traveling including any one of obstacle avoidance, stop, and deceleration. Accordingly, in the case of performing passing, overtaking, or the like with respect to a preceding vehicle by self-driving, it is possible to appropriately perform travel control according to a road state.

In addition, when both passing and overtaking are possible for the own vehicle, the determination unit 11 determines which of passing and overtaking is suitable based on the sensor detection information, and outputs a determination result of performing a preferable one of passing and overtaking. Accordingly, when passing and overtaking are possible at a current position, a preferable one of passing and overtaking is selected according to a road situation such as presence or absence of an oncoming vehicle and travel control is execute, and thus it is possible to appropriately control traveling according to the road state.

In addition, when passing is possible but overtaking is not possible for the own vehicle, the determination unit 11 outputs a determination result of performing passing. Accordingly, when overtaking is not possible but passing is possible at a current position, travel control of performing passing without entering an oncoming lane is executed, and thus it is possible to appropriately control traveling according to the road state.

In addition, when passing is not possible for the own vehicle, the determination unit 11 acquires image information on the surroundings of the own vehicle as sensor detection information, and identifies an obstacle based on the image information. Accordingly, when passing and overtaking are not possible at a current position, an obstacle in front is identified, and thus it is possible to perform appropriate travel control according to a type of the obstacle, such as a parked vehicle, a passenger vehicle, a stopped vehicle, and other vehicles.

In addition, when the obstacle is a parked vehicle, the determination unit 11 outputs a determination result of performing obstacle avoidance of the parked vehicle. Accordingly, when the obstacle in front is a parked vehicle, travel control is executed to perform obstacle avoidance, and thus it is possible to appropriately control traveling according to the road state.

In addition, when the obstacle is a vehicle in traveling, the determination unit 11 outputs a determination result of stopping or decelerating the own vehicle behind the vehicle traveling in front. Accordingly, when the obstacle in front is a vehicle in traveling, travel control is executed to stop or decelerate the own vehicle behind the vehicle traveling in front, and thus it is possible to appropriately control traveling according to the road state. For example, when the vehicle in front is a passenger vehicle, control of stopping or decelerating the own vehicle so as to allow the passenger vehicle to travel first can be executed. In addition, when the vehicle in front is a stopped vehicle that is stopped at a stop line, it is possible to execute control of stopping the own vehicle so as not to come in front of the stopped vehicle.

In addition, when passing is not possible but overtaking is possible for the own vehicle, the determination unit 11 outputs a determination result of performing overtaking. Accordingly, travel control of performing overtaking is executed under a condition that passing is not possible but overtaking is possible, and thus it is possible to appropriately control traveling according to the road state.

Although various embodiments are described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Components in the various embodiments described above may be combined freely within a range not departing from the spirit of the invention.

The present application is based on Japanese Patent Application No. 2019-068783 filed on Mar. 29, 2019, the contents of which are incorporated herein by reference.

The present disclosure has an effect of making it possible to appropriately control traveling of a vehicle such as overtaking, and is useful as a vehicle control device, a vehicle control method, and a program for controlling traveling of a vehicle.

1. A vehicle control device configured to control traveling of a vehicle capable of self-driving, the vehicle control device comprising:
a processor; and
a memory storing instructions that, when executed by the processor, cause the vehicle control device to perform operations comprising:
determining a control condition related to vehicle traveling when an own vehicle as a control target vehicle is in automated traveling by self-driving; and
controlling traveling of the own vehicle based on a determination result,
wherein the determining the control condition comprises, in a case in which an obstacle is present in front of the own vehicle, determining, as the control condition, whether passing is possible and further whether overtaking is possible, and
wherein the controlling the traveling of the own vehicle comprises executing the passing or the overtaking or another travel control in accordance with whether the passing is possible and whether the overtaking is possible.

2. The vehicle control device according to claim 1,
wherein the passing is vehicle traveling in which the own vehicle comes in front of a preceding vehicle without entering an oncoming lane of a road on which the own vehicle is traveling, and
wherein the overtaking is vehicle traveling in which the own vehicle comes in front of the preceding vehicle by entering the oncoming lane.

3. The vehicle control device according to claim 1,
wherein the operations further comprise:
acquiring sensor detection information on surroundings of the own vehicle detected by a sensor and map information; and
acquiring own-vehicle position information indicating a position of the own vehicle based on the sensor detection information and the map information, and
wherein whether the passing and the overtaking are possible is determined based on the own-vehicle position information.

4. The vehicle control device according to claim 3,
wherein the sensor detection information comprises image information on surroundings of the own vehicle, and
wherein whether the passing and the overtaking are possible is determined based on an image recognition using the image information.

5. The vehicle control device according to claim 4,
wherein the image recognition comprises recognizing at least one of a road sign and a road marking.

6. The vehicle control device according to claim 4,
wherein the determining whether the passing is possible comprises determining whether a space for passing exists in a traveling lane based on the image recognition.

7. The vehicle control device according to claim 4,
wherein the determining whether the overtaking is possible comprises determining whether entering an oncoming lane is prohibited based on the image recognition.

8. The vehicle control device according to claim 3,
wherein the determining whether the overtaking is possible comprises recognizing a road on which the own vehicle is travelling and a position on the road based on the own-vehicle position information and determining whether entering an oncoming lane is possible.

9. The vehicle control device according to claim 1,
wherein the another travel control comprises any one of obstacle avoidance, stop, and deceleration.

10. The vehicle control device according to claim 3,
wherein the determining the control condition comprises, in a case in which both the passing and the overtaking are possible for the own vehicle, determining which of the passing and the overtaking is suitable based on the sensor detection information, and outputting a determination result for performing a preferable one of the passing and the overtaking.

11. The vehicle control device according to claim 10,
wherein which of the passing and the overtaking is suitable is determined based on at least one of presence or absence of an oncoming vehicle, a speed of the own vehicle, a speed of a preceding vehicle.

12. The vehicle control device according to claim 10,
wherein which of the passing and the overtaking is suitable is determined based on at least one of a width of a traveling lane, an interval between the own vehicle and a preceding vehicle, presence or absence of an oncoming vehicle.

13. The vehicle control device according to claim 1,
wherein the determining the control condition comprises, in a case in which the passing is possible but the overtaking is not possible for the own vehicle, outputting a determination result for performing the passing.

14. The vehicle control device according to claim 3,
wherein the determining the control condition comprises, in a case in which the passing is not possible for the own vehicle, acquiring image information on surroundings of the own vehicle as the sensor detection information, and identifying the obstacle based on the image information.

15. The vehicle control device according to claim 14,
wherein the determining the control condition comprises, in a case in which the obstacle is a parked vehicle, outputting a determination result for performing obstacle avoidance of the parked vehicle.

16. The vehicle control device according to claim 15,
wherein the obstacle avoidance is determined in accordance with a road situation ahead the parked vehicle.

17. The vehicle control device according to claim 14,
wherein the determining the control condition comprises, in a case in which the obstacle is a vehicle in traveling, outputting a determination result for stopping or decelerating the own vehicle behind the vehicle traveling in front.

18. The vehicle control device according to claim 1,
wherein the determining the control condition comprises, in a case in which the passing is not possible but the overtaking is possible for the own vehicle, outputting a determination result for performing the overtaking.

19. A vehicle control method in a vehicle control device configured to control traveling of a vehicle capable of self-driving, the vehicle control method comprising:
determining a control condition related to vehicle traveling when an own vehicle as a control target vehicle is in automated traveling by self-driving; and
controlling traveling of the own vehicle based on a determination result,
wherein the determining the control condition comprises, in a case in which an obstacle is present in front of the own vehicle, determining whether passing is possible and further whether overtaking is possible as the control condition, and
wherein the controlling the traveling of the own vehicle comprises executing the passing or the overtaking or another travel control in accordance with whether the passing is possible and whether the overtaking is possible.

20. A non-transitory computer-readable medium storing a program that, when executed by a processor, cause a computer to execute a vehicle control method for controlling traveling of a vehicle capable of self-driving,
the vehicle control method comprising:
determining a control condition related to vehicle traveling when an own vehicle as a control target vehicle is in automated traveling by self-driving; and
controlling traveling of the own vehicle based on a determination result,
wherein the determining the control condition comprises determining, as the control condition, whether passing is possible and further whether overtaking is possible in a case in which an obstacle is present in front of the own vehicle, and
wherein the controlling the traveling of the own vehicle comprises executing the passing or the overtaking or another travel control in accordance with whether the passing is possible and whether the overtaking is possible.
